(19) United States
(12) Patent Application Publication
(10) Pub. No.: US 2013/0198351 A1
(43) Pub. Date: Aug. 1, 2013

(54) Flexible Caching in a Content Centric Network

(71) Applicants: Indra Widjaja, Roseland, NJ (US); Mangjun Xie, Little Rock, AR (US)

(72) Inventors: Indra Widjaja, Roseland, NJ (US); Mangjun Xie, Little Rock, AR (US)

(73) Assignee: ALCATEL-LUCENT USA INC, Murray Hill, NJ (US)

(21) Appl. No.: 13/359,863

(22) Filed: Jan. 27, 2012

(51) Int. Cl. G06F 15/173

(52) U.S. Cl. 709/223

(57) ABSTRACT

Flexible caching techniques are provided for a content centric network. A content object is selectively stored in a cache of a named-based network following a cache miss by storing a name of the content object in the cache following the cache miss; obtaining the content object from another node in the named-based network; and selectively storing the obtained content object in the cache. An additional parameter that quantifies a predefined caching objective can optionally be stored with the name. An objective function can be evaluated based on the additional parameter and the selective storage of the obtained content object can be based on an evaluation of the objective function. The predefined caching objective can be, e.g., an improved robustness to an attack or improved energy efficiency.

### FIELD OF THE INVENTION

The present invention relates generally to content processing techniques, and more particularly to techniques for caching content in a content centric networks (CCN).

### BACKGROUND OF THE INVENTION

In content centric networks (CCNs), names are assigned to each content object, and the assigned name is used to request and return the content objects (rather than addresses). For a detailed description of CCNs, see, for example, V. Jacobson et al., “Networking Named Content,” ACM Int'l Conf. on emerging Networking Experiments and Technologies (CoNEXT), 1-12 (2009), incorporated by reference herein. Generally, content is routed through a CCN network based on the assigned name. CCN addresses the explosive growth of available content more flexibly and efficiently than current Internet approaches. CCN networks employ a cache, also referred to as a Content Store, at every CCN router in a network so that each content object will likely be served by a router closest to any end user. In this manner, a user can obtain a content object from the closest router that has the requested object.

Caches often employ a cache replacement policy based on, for example, the recency and/or frequency of requests for the content object, such as a Least-Recently-Used (LRU) or a Least-Frequently-Used (LFU) cache replacement strategy. These solutions, however, are not sufficient when attackers request objects in a manner that deviates from those normally requested by legitimate users. For example, a cache pollution attack can adversely impact CCN networks. In a cache pollution attack, the attackers request content objects from content servers uniformly, which has the impact of maximally destroying content locality in a cache. Typically, performance is degraded by requesting unpopular content objects, to thereby displace more popular content objects from the caches. Detection of such attacks presents additional challenges in a CCN network, since addresses may not be available to identify the attackers.

A need exists for improved caching systems for CCN networks that maintain cache robustness in the face of such attacks. A further need exists for improved caching systems that determine whether to store a given content item in the cache based on one or more objectives, such as improved energy consumption by caching content objects in CCN routers further away from the corresponding origin content servers than those located near the servers.

### SUMMARY OF THE INVENTION

Generally, flexible caching techniques are provided for a content centric network. According to one aspect of the invention, a content object is selectively stored in a cache of a named-based network following a cache miss by storing a name of the content object in the cache following the cache miss; obtaining the content object from another node in the named-based network; and selectively storing the obtained content object in the cache.

According to a further aspect of the invention, an additional parameter can optionally be stored with the name, wherein the additional parameter quantifies a predefined caching objective. An objective function can be evaluated based on the additional parameter and the selective storage of the obtained content object is based on an evaluation of the objective function.

For example, the predefined caching objective can be improved robustness to an attack and the additional parameter can comprise a number of requests for the content object. In a further variation, the predefined caching objective can be improved energy efficiency and the additional parameter can comprise a number of hops required to obtain the content object.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional CCN router;

FIG. 2 illustrates the exemplary conventional cache of FIG. 1 in further detail;

FIG. 3 illustrates an exemplary CCN router incorporating flexible caching aspects of the present invention;

FIG. 4 illustrates the exemplary cache of FIG. 3 in further detail;

FIG. 5 illustrates an exemplary name record for the cache of FIG. 4;

FIG. 6 is a flow chart describing an exemplary implementation of a next-hop content forwarding process that incorporates aspects of the present invention;

FIG. 7 is a flow chart describing an exemplary implementation of a next-hop content receiving process that incorporates aspects of the present invention; and

FIGS. 8A and 8B are flow charts describing alternative exemplary implementations of a decision function for the exemplary router of FIG. 3.

### DETAILED DESCRIPTION

The present invention provides improved techniques for flexible caching in a Content Centric Network. According to one aspect of the invention, content objects and content names are stored in a content store rather than separately in a content store and pending interest table, as with conventional CCN approaches. According to a further aspect of the invention, the content names are stored with additional information, such as Request Number and Hop Count, that can be employed by a Decision Function to address new objectives when determining whether or not to store a given content object in the cache, such as maintaining cache robustness in the face of a pollution attack or improving energy efficiency.

While the present invention is illustrated herein in the context of exemplary CCN networks, the present invention can be implemented in other named-based caching networks, as would be apparent to a person of ordinary skill in the art.

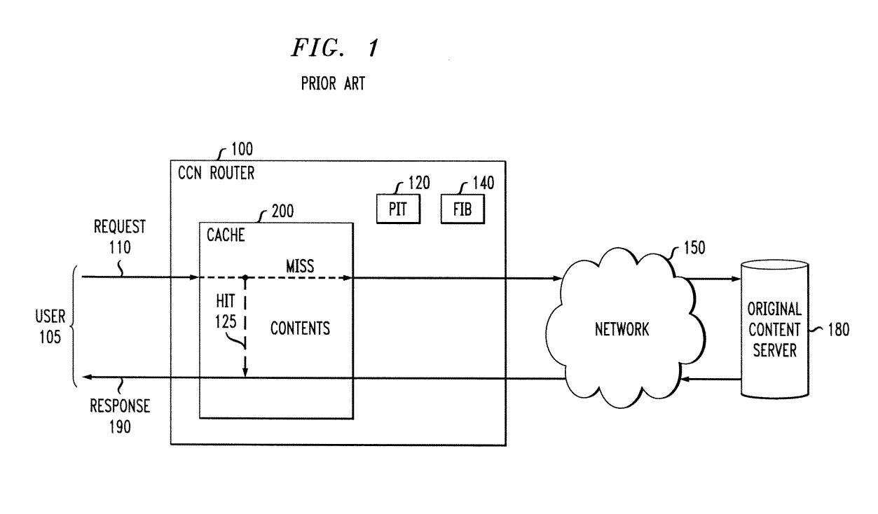

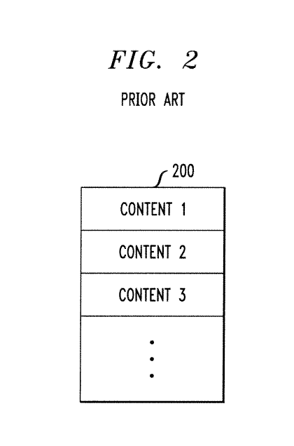

FIG. 1 illustrates a conventional CCN router 100. The router 100 comprises a cache 200, discussed further below in conjunction with FIG. 2. In addition, the router 100 employs a Pending Interest Table (PIT) 120 and a Forwarding Information Base (FIB) 140. The PIT 120 keeps track of pending requests (called “interests”) for content objects that cannot be located at a given router. The FIB 140 is similar to an IP forwarding table except that lookup is based on content names rather than IP addresses.

As shown in FIG. 1, requests 110 from a user 105 are propagated through a network 150 toward an origin content server 180. Any router, such as the router 100, that has the requested content will trigger a “hit,” terminate the request and reply with the content, as indicated by a vertical “hit arrow” 125 in FIG. 1. Otherwise, a “miss” is indicated, and the router 100 will forward the request 110 to the next hop in the network 150 towards the origin content server 180. In each router 100, a cache 200 plays an important role in improving network efficiency and enhancing the experience of the user 105. When there is a request 110, the router 100 having the content that is closest to the user 105 along the path to the origin content server 180 will terminate the request 110 and deliver the content in a response 190.

FIG. 2 illustrates the exemplary conventional cache 200 of FIG. 1 in further detail. For ease of illustration, assume that the exemplary conventional cache 200 employs a LRU cache replacement policy. As shown in FIG. 2, the exemplary conventional cache 200 places the most recently requested/used content (Content 1) at the top of the cache 200. The second most recently requested content (Content 2) is placed in the second position, just below the top of the cache 200. When a new request 110 results in a hit at some position in a cache 200, the corresponding content will be moved to the top and other contents above it will be moved down by one position. When a new request 110 results is a miss, the content will be fetched remotely and placed at the top of the cache 200. Other content in the cache 200 will be moved down by one position, in a known manner. If storing a new content object results in an overflow of the cache 200, the content object(s) at the bottom of the cache 200 (i.e., the objects that are least recently used) will be evicted from the cache 200 to make room for the new content.

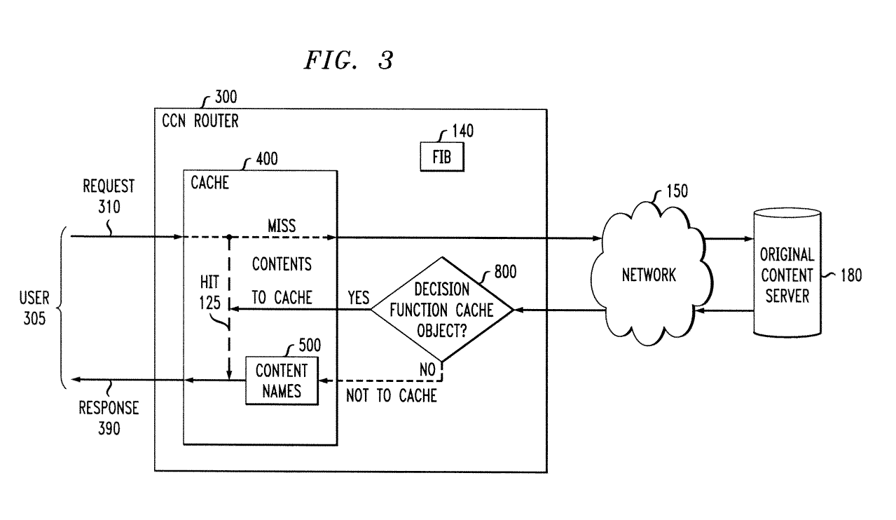

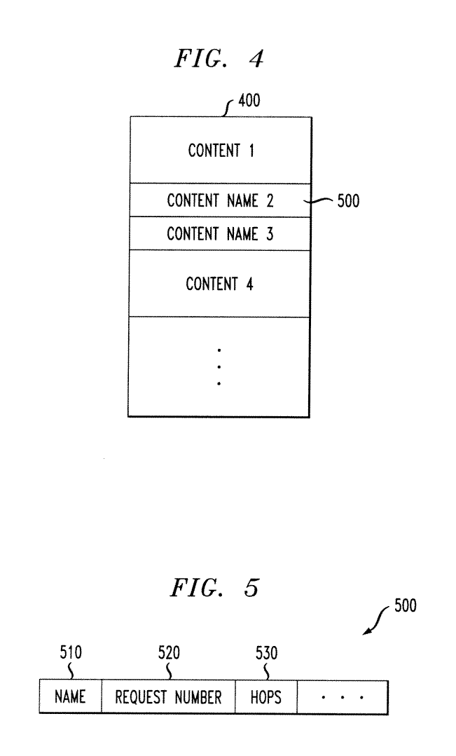

FIG. 3 illustrates an exemplary CCN router 300 incorporating flexible caching aspects of the present invention. The router 300 comprises a cache 400, discussed further below in conjunction with FIG. 4. In addition, the router 300 employs a Forwarding Information Base (FIB) 140, in a similar manner to FIG. 1. The exemplary CCN router 300 does not include a PIT 120. Rather, the content names are moved to the cache 400.

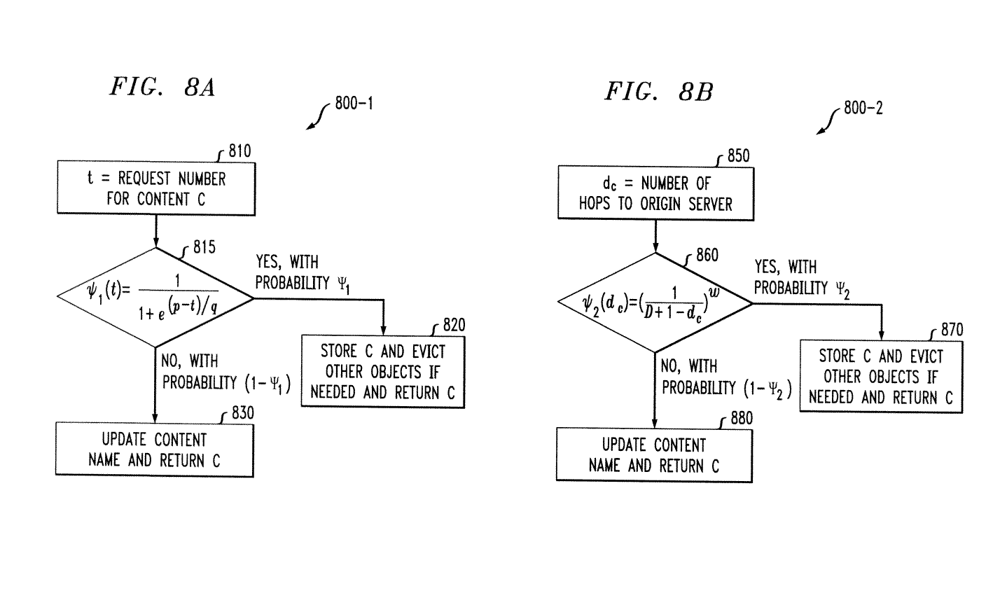

As discussed further below in conjunction with FIGS. 4 and 5, the cache 400 also comprises content name records 500. Thus, the cache 400 comprises content objects as well as content names (both subject to the same replacement policy). The name records 500 optionally contain additional fields that are utilized by a new Decision Function (DF) 800, discussed further below in conjunction with FIG. 8, to achieve an objective that can be configured by an operator (for example, “mitigate attack type x”, “enable energy efficiency”, etc.). Each of the objectives may use a different set of fields to control caching of objects.

As shown in FIG. 3, requests 310 from a user 305 are propagated through a network 150 toward an origin content server 180. Any router, such as the router 300, that has the requested content will trigger a “hit,” terminate the request 310 and reply with the content, as indicated by a vertical “hit arrow” 125 in FIG. 3. In this case, the router 300 in FIG. 3 operates in a similar manner to the router 100 of FIG. 1.

Otherwise, when there is a miss and the content object needs to be fetched remotely, the Decision Function (DF) 800 will determine whether or not to cache the content object when it is returned. If the object is not already cached, the corresponding name, if not yet present, will be added to the cache 400 instead. The DF 800 can utilize additional stored information to better control caching. For example, to protect against pollution attack as described below, the DF 800 can rely on the number of requests that have been made for a given object that is not cached.

Thus, when a request 310 finds a matching content name but the DF 800 decides not to cache the content object, the number of requests attempted are recorded in the cache 400 along with the content name. This number of requests can be used for future decisions by the DF 800. On the other hand, if the DF 800 decides to cache the content object, then the content name, if present, is removed and the new content object is placed at the top (a content object actually has a content name in its header). When content object C needs to be evicted to make room for a new content object, all content names below C will also be evicted.

FIG. 4 illustrates the exemplary cache 400 of FIG. 3 in further detail. For ease of illustration, assume that the exemplary conventional cache 400 employs a LRU cache replacement policy. Generally, for a given content object, the exemplary cache 400 stores either the content object itself, or the corresponding name of the content object, based on the decision function 800. As shown in FIG. 4, the exemplary cache 400 places the most recently requested/used content (Content 1) at the top of the cache 400. The name of the second most recently requested content (ContentName 2) is placed in the second position, just below the top of the cache 400. When a new request 110 results in a hit at some position in a cache 400, the corresponding content will be moved to the top and other contents above it will be moved down by one position. When a new request 110 results is a miss, the content or corresponding content name will be fetched remotely and placed at the top of the cache 400. Other content in the cache 400 will be moved down by one position, in a known manner. If storing a new content object results in an overflow of the cache 400, the content object(s) at the bottom of the cache 400 (i.e., the objects or names that are least recently used) will be evicted from the cache 400 to make room for the new content.

As shown in FIG. 4, content names are stored in name records 500 for the objects associated with the second and third positions. FIG. 5 illustrates an exemplary name record 500. Each name record 500 comprises the name of a corresponding content object in record 510. In addition, the exemplary name record 500 optionally also comprises a record 520 indicating a number of requests for the object, and a record 530 indicating the number of hops to the content object or any other fields that can help the DF make a decision. Thus, a content name can be considered a reservation placeholder for the content. The information cached for a content name and a content object are different. A content name is thus significantly shorter than the content object itself. Thus, the additional space required by content names is typically negligible compared to that required by content objects.

As indicated above, content names stored in a cache 400 can also contain additional information that can be manipulated by the DF 800 to make a better decision to cache or not to cache a given content object. For example, for an energy-efficiency objective, the DF 800 may rely on the number of hops to an origin content server 180 and other relevant parameters. In this manner, content objects that are far away from an origin server 180 can be preferred since a miss will likely result in consuming energy on more routers 300. Thus, the method may prefer to cache a content object that has a higher hop count. The disclosed router 300 allows for other fields to be added and the DF 800 to be programmable to incorporate new objectives.

FIG. 6 is a flow chart describing an exemplary implementation of a next-hop content forwarding process 600. When a request for content object C arrives at a router, the content object is directly returned by the router during step 615 if it is determined during step 610 that the object C is in the cache 300. If, however, it is determined during step 610 that the content object C is not in the cache 300, but it is determined during step 620 that the content name of content object C is in the cache 300, then the entry is adjusted during step 625, if needed. For example, this may include recording a new interface number. Otherwise, if it is determined during step 620 that the content name is also not in the cache (i.e., a cache miss), the content name is stored during step 630 and the request is forwarded to the next-hop router 300 which may eventually reach the origin content server 180 if none of the routers along the path has the requested object.

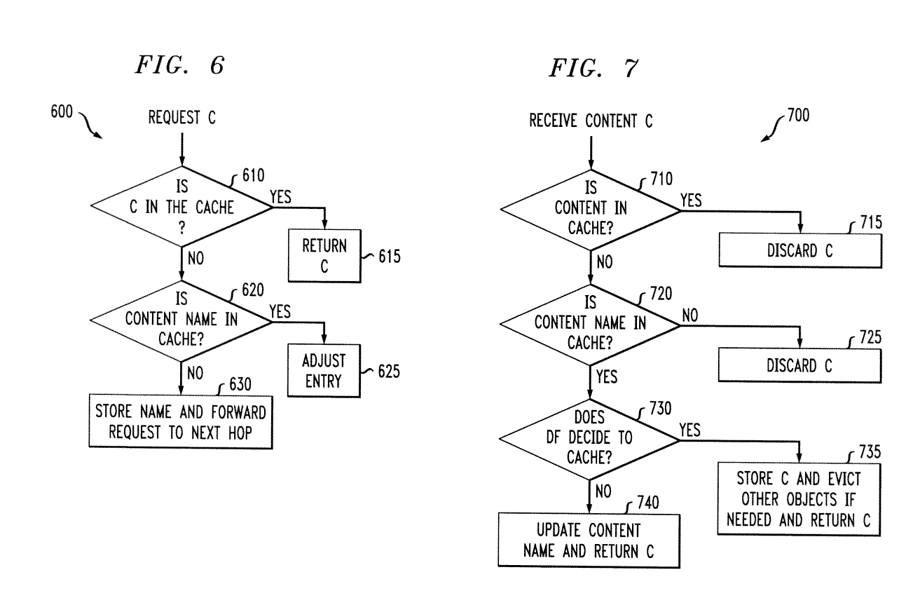

FIG. 7 is a flow chart describing an exemplary implementation of a next-hop content receiving process 700. As shown in FIG. 7, when a router 300 receives a requested content object from its next-hop router or a server, the router 300 checks the cache during step 710. If it is determined during step 710 that the cache 400 already has the content object because it has received the same copy previously from another router, the process 700 simply discards the object during step 715. Otherwise, if it is determined during step 720 that the router 300 does not find a matching content name, the process 700 discards the content object during step 725. This situation may arise because the content name has timed-out (e.g., been evicted by the replacement algorithm).

If it is determined during step 720 that the content name is found in the cache, then the DF 800 makes a decision during step 730 about whether or not to cache the content object C. If the DF 800 decides to cache the object, the DF 800 stores the content object, removes the content name and returns the content object C to the user during step 735. Otherwise, the DF 800 updates the content name and returns the content object C to the user during step 740.

FIGS. 8A and 8B are flow charts describing alternative exemplary implementations of a decision function 800 and 800′, respectively (and collectively referred to as decision functions 800). As previously indicated, the decision functions 800 determine whether a given router should store a given content object in the cache, based on one or more different methods for different objectives. FIG. 8A illustrates a decision function 800 based on defending against pollution attacks. FIG. 8B illustrates a decision function 800 based on energy-efficient caching.

As shown in FIG. 8A, the exemplary decision function 800 assigns a request number for content C to a variable t during step 810. During step 815, decision function 800 evaluates an objective function, ψ₁, as follows:

$${ψ}_{1} ( t ) = \frac{1}{1 + {e}^{( p - t ) / q}} ,$$

where t denotes the t-th request of a given content object and is recorded in the Request# field of the name record 500, and p and q are parameters of the function.

With probability ψ₁, the content object is stored in the cache 400 during step 820 for possible future use. In addition, other objects in the cache 400 may be evicted, if needed, to make room for C and C is returned.

With probability (1−ψ₁) the content object is not stored in the cache 400 during step 830. In addition, the content name for C is stored in the cache 400 using a name record 500 and object C is returned.

As shown in FIG. 8B, the exemplary decision function 800′ assigns a number of hops to the origin server 180 for the content C to a variable d_{c} during step 850. During step 860, decision function 800 evaluates an objective function, ψ₂, as follows:

$${ψ}_{2} ( {d}_{c} ) = {( \frac{1}{D + 1 - {d}_{c}} )}^{w} ,$$

where d_{c} is the number of hops toward the origin server 180 hosting content C and is recorded in the Hops field of the exemplary name record 500, D is the network diameter and w is a weighting parameter.

With probability ψ₂ , the content object is stored in the cache during step 870 for possible future use. In addition, other objects in the cache 400 may be evicted, if needed, to make room for C and C is returned.

With probability (1−ψ₂), the content object is not stored in the cache 400 during step 880. In addition, the content name for C is stored in the cache 400 using a name record 500 and object C is returned.

Other methods with different objectives generally can be incorporated into the decision function 800 and may use different information fields in the name records 500, as would be apparent to a person of ordinary skill in the art. For example, popularity information may optionally be included in the name records 500.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

Accordingly, computer software including instructions or code for performing the methodologies of the invention, as described herein, may be stored in one or more associated memory devices and, when ready to be utilized, loaded in part or in whole and implemented by a CPU or other processing circuitry. The memory elements can include local memory employed during actual implementation of the program code, bulk storage, and cache memories which provide temporary storage of at least some program code in order to reduce the number of times code must be retrieved from bulk storage during implementation.

As previously indicated, the disclosed CCN routers, as described herein, provide a number of advantages relative to conventional arrangements. As indicated above, the disclosed techniques allow a router to determine whether a given content object should be stored in a cache, based on one or more objectives. Among other benefits the disclosed caching system allows for incremental deployment and does not require interoperability among different routers.

It is emphasized that the above-described embodiments of the invention are intended to be illustrative only. In general, the exemplary CCN routers can be modified, as would be apparent to a person of ordinary skill in the art, to incorporate alternative decision functions based on different objectives. In addition, the disclosed techniques for flexible caching can be employed in any named-based caching networks, as would be apparent to a person of ordinary skill in the art.

While exemplary embodiments of the present invention have been described with respect to digital logic blocks, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

It is to be understood that the embodiments and variations shown and described herein are merely illustrative of the principles of this invention and that various modifications may be implemented by those skilled in the art without departing from the scope and spirit of the invention.

We claim:

1. A method for determining whether to store a content object in a cache of a named-based network following a cache miss, comprising:
storing a name of said content object in said cache following said cache miss;
obtaining said content object from another node in said named-based network; and
selectively storing said obtained content object in said cache.

2. The method of claim 1, wherein said step of storing said name further comprises storing at least one additional parameter with said name, wherein said additional parameter quantifies a predefined caching objective.

3. The method of claim 2, further comprising the step of evaluating an objective function based on said additional parameter and wherein said step of selectively storing said obtained content object is based on an evaluation of the objective function.

4. The method of claim 2, further comprising the step of updating said additional parameter.

5. The method of claim 2, wherein said predefined caching objective comprises improved robustness to an attack and wherein said additional parameter comprises a number of requests for said content object.

6. The method of claim 2, wherein said predefined caching objective comprises improved energy efficiency and wherein said additional parameter comprises a number of hops required to obtain said content object.

7. An apparatus for determining whether to store a content object in a cache following a cache miss, comprising:
a memory; and
at least one hardware device, coupled to the memory, operative to:
store a name of said content object in said cache following said cache miss;
obtain said content object from another node in said named-based network; and
selectively store said obtained content object in said cache.

8. The apparatus of claim 7, wherein said at least one hardware device is further configured to store at least one additional parameter with said name, wherein said additional parameter quantifies a predefined caching objective.

9. The apparatus of claim 8, wherein said at least one hardware device is further configured to evaluate an objective function based on said additional parameter and wherein said step of selectively storing said obtained content object is based on an evaluation of the objective function.

10. The apparatus of claim 8, wherein said at least one hardware device is further configured to update said additional parameter.

11. The apparatus of claim 8, wherein said predefined caching objective comprises improved robustness to an attack and wherein said additional parameter comprises a number of requests for said content object.

12. The apparatus of claim 8, wherein said predefined caching objective comprises improved energy efficiency and wherein said additional parameter comprises a number of hops required to obtain said content object.

13. An article of manufacture for determining whether to store a content object in a cache following a cache miss, comprising a tangible machine readable recordable medium containing one or more programs which when executed implement the steps of:
storing a name of said content object in said cache following said cache miss;
obtaining said content object from another node in said named-based network; and
selectively storing said obtained content object in said cache.

14. The article of manufacture of claim 13, wherein said step of storing said name further comprises storing at least one additional parameter with said name, wherein said additional parameter quantifies a predefined caching objective.

15. The article of manufacture of claim 14, further comprising the step of evaluating an objective function based on said additional parameter and wherein said step of selectively storing said obtained content object is based on an evaluation of the objective function.

16. The article of manufacture of claim 14, further comprising the step of updating said additional parameter.

17. The article of manufacture of claim 14, wherein said predefined caching objective comprises improved robustness to an attack and wherein said additional parameter comprises a number of requests for said content object.

18. The article of manufacture of claim 14, wherein said predefined caching objective comprises improved energy efficiency and wherein said additional parameter comprises a number of hops required to obtain said content object.
